(19) United States
(12) Patent Application Publication
(10) Pub. No.: US 2015/0007989 A1
(43) Pub. Date: Jan. 8, 2015

(54) VISCOELASTIC SURFACTANTS CROSSLINKED WITH DIVALENT IONS AND METHODS FOR MAKING AND USING SAME

(71) Applicant: Clearwater International, LLC, Houston, TX (US)

(72) Inventors: Hyok Chong Tan, Dubai (AE); Billy J. Gray, Houston, TX (US)

(21) Appl. No.: 14/322,688

(22) Filed: Jul. 2, 2014

Related U.S. Application Data
(60) Provisional application No. 61/842,866, filed on Jul. 3, 2013.

(51) Int. Cl. C09K 8/60; E21B 43/16

(52) U.S. Cl. CPC C09K 8/604; E21B 43/16; C09K 2208/30
USPC 166/279; 507/225

(57) ABSTRACT

Viscoselastic surfactant systems including at least one viscoelastic surfactant and at least one divalent metal compound, where the systems are useable for enhancing oil production in oil wells that coproduce high volumes of gas and/or water and for enhancing gas injection uniformity into injection formations and methods including treating producing or injecting formations with the systems to enhance oil production in treated producing zones or enhance injection efficiency in injection zones.

### RELATED APPLICATIONS

This application claims the benefit of and priority to U.S. Provisional Patent Application Ser. No. 61/842,866 filed Jul. 3, 2013 (3 Jul. 2013).

### BACKGROUND OF THE INVENTION

1. Field of the Invention

Embodiments of this invention related to viscoelastic surfactant (VES) systems for use in producing and injecting formations, and to methods for making and using same.

Embodiments of this invention related to VES systems for use in producing and injecting formations, and to methods for making and using same, where the VES systems include at least one VES and at least one divalent metal ion solution. 2. Description of the Related Art

Viscoelastic surfactant systems have been used extensively in oil and gas production as is evidenced in the large number of patents relating to the use of VES systems in oil and gas production. See for example U.S. Pat. Nos. 4,695,389; 4,725,372; 5,551,516; 5,964,295; and 5,979,557. However, these VES systems all require or are used in conjunction with acidizing treatments of oil and gas wells.

Thus, there is a need in the art for VES systems that do not require acidizing cotreatments for effectiveness and may be used in any type of formation including limestone, sandstone, or other formation types.

### SUMMARY OF THE INVENTION

Embodiments of this invention related to viscoelastic surfactant (VES) systems for use in producing and injecting formations, and to methods for making and using same.

Embodiments of this invention related to VES systems for use in producing and injecting formations, and to methods for making and using same, where the VES systems include at least one VES and at least one divalent metal ion solution and may also include a base fluid.

Embodiments of this invention provide methods comprising providing a fluid including at least one viscoelastic surfactant (VES) and at least one divalent metal compound and may also include a base fluid, where the fluid forms a crosslinked gel having desired shear thinning characteristics and desired oil breaking or oil dissolving properties. The methods also include placing the fluid in a well bore adjacent a subterranean formation, and then allowing the fluid to penetrate the formation over a period of time sufficient for a desired depth of penetration. In certain embodiments, the penetration depth is between about 1 metes and 50 meters. In other embodiments, the penetration depth is between about 1 meter and about 40 meters. In other embodiments, the penetration depth is between about 1 meter and about 30 meters. In other embodiments, the penetration depth is between about 1 meter and about 20 meters. In other embodiments, the penetration depth is between about 1 meter and about 10 meters. In other embodiments, the penetration depth is greater than 1 meter. In other embodiments, the penetration depth is greater than 2 meters. In other embodiments, the penetration depth is greater than 3 meters. In other embodiments, the penetration depth is greater than 4 meters. In other embodiments, the penetration depth is greater than 5 meters. In other embodiments, the penetration depth is greater than 10 meters. In other embodiments, the penetration depth is greater than 15 meters. In other embodiments, the penetration depth is greater than 20 meters. In certain embodiments, the viscoelastic surfactants are selected from the group consisting of amphoteric/cationic surfactants, viscosifying amphoteric/cationic surfactants, or mixtures and combinations thereof. In other embodiments, the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides (fluoride, chloride, bromide); carbonate; hydroxide; carboylates (formate, acetate, etc.); nitrate; sulfate; phosphate; or mixtures and combinations thereof. In other embodiments, the base fluid is an aqueous-based fluid. In still other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a non-emulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; or mixtures and combinations thereof.

Embodiments of this invention also provide methods comprising providing an aqueous fluid including at least one viscoelastic surfactant (VES) and at least one divalent metal compound, where the fluid forms a crosslinked gel having desired shear thinning characteristics and desired oil breaking or oil dissolving properties; placing the fluid in a well bore; and presssurizing the fluid for a time and at a pressure sufficient for the fluid to penetrate the subterranean formation enhancing oil production and/or enhancing gas flooding efficiency. In certain embodiments, the viscoelastic surfactants are selected from the group consisting of amphoteric/cationic surfactants, viscosifying amphoteric/cationic surfactants, or mixtures and combinations thereof. In other embodiments, the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides (fluoride, chloride, bromide); carbonate; hydroxide; carboylates (formate, acetate, etc.); nitrate; sulfate; phosphate; or mixtures and combinations thereof. In other embodiments, the base fluid is an aqueous-based fluid. In yet other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; or mixtures and combinations thereof.

Embodiments of this invention also provide methods comprising providing a fluid including at least one viscoelastic surfactant and at least one divalent metal compound and a base fluid, where the fluid forms a crosslinked gel having desired shear thinning characteristics and desired oil breaking or oil dissolving properties; placing the fluid in a well bore adjacent a subterranean formation; allowing the fluid to penetrate the formation to form a treated formation; and injecting gas into the treated formation. In certain embodiments, the viscoelastic surfactants are selected from the group consisting of amphoteric/cationic surfactants, viscosifying amphoteric/cationic surfactants, or mixtures and combinations thereof. In other embodiments, the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides (fluoride, chloride, bromide); carbonate; hydroxide; carboylates (formate, acetate, etc.); nitrate; sulfate; phosphate; or mixtures and combinations thereof. In other embodiments, the base fluid is an aqueous-based fluid. In yet other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; or mixtures and combinations thereof.

Embodiments of this invention also provide methods comprising providing a fluid including at least one viscoelastic surfactant and at least one divalent metal compound and may also include a base fluid, where the fluid forms a crosslinked gel having desired shear thinning characteristics and desired oil breaking or oil dissolving properties; placing the fluid in a well bore adjacent a subterranean formation; allowing the fluid to penetrate the formation to form a treated formation; and placing the formation on production, where the crosslinked gel blocks gas and/or water production in gas and/or water producing zones, while breaking or dissolving in oil producing zones. In certain embodiments, the viscoelastic surfactants are selected from the group consisting of amphoteric/cationic surfactants, viscosifying amphoteric/cationic surfactants, or mixtures and combinations thereof. In other embodiments, the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides (fluoride, chloride, bromide); carbonate; hydroxide; carboylates (formate, acetate, etc.); nitrate; sulfate; phosphate; or mixtures and combinations thereof. In yet other embodiments, the base fluid is an aqueous-based fluid. In yet other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; or mixtures and combinations thereof.

### BRIEF DESCRIPTION OF THE DRAWINGS

The invention can be better understood with reference to the following detailed description together with the appended illustrative drawings in which like elements are numbered the same:

FIG. 1 depicts viscosity versus temperature curves for visco-elastic surfactants in different calcium chloride brines.

FIG. 2 depicts regain brine permeability to 7% AGA-400MEV in 20% CaCl₂.

FIG. 3 depicts regain brine permeability to 7% AGA-400MEV in 20% CaCl₂ slug.

### DETAILED DESCRIPTION OF THE INVENTION

The inventors have found that viscoelastic surfactants (VESs), when mixed in water containing up to 20% CaCl₂ form 3D crosslinked gels. The crosslinked gels will only be broken, when they contact oil. At high shear rates, while pumping down tubular members, the gels exhibit low viscosities. But when the gels enter into a matrix formation, their viscosities increase with decreasing shear rate. The crosslinked gel may be easily broken, when contacted with oil. This system may be used (1) as a gas permeability reducing agent to modify a gas oil ratio, (2) as a water permeability reducing agent in oil and gas wells that produce water containing high divalent ions (such as Ca²⁺,Mg²⁺, etc.), and (3) to improve injection profiles for gas injection wells. Applications using these VES viscosfied CaCl₂ brines may operate in a temperature range between 50° F. to 200° F.

VES compositions, when added to 15 wt. % to 20 wt. % HCl acid solutions, will also form 3D crosslinked gels. These gel system has been used by Weatherford and other service companies as acidizing diverting agent in matrix acidizing. VES compositions have also been used as a friction reducers and viscosifiers for hydraulic fracturing and acid fracturing treatments by many service companies. Schlumberger has also used VES compositions in HCl as a water control treatment, but in limestone formations only.

As gas permeation reducing compositions, in some cases, the operators may want to reduce gas production in their oil wells. In this case, VES compositions in a 20% CaCl₂ brine may be bullheaded down production tubing. The fluid permeating the gas zone will remain crosslinked, thus reducing gas production, while, the fluid permeating the oil zones will be broken and allow continued oil production.

As water permeation reducing compositions in oil and gas wells producing water containing high concentrations of divalent ions, VES compositions may be bullheaded into the formation to control the water production. When the VES compositions contact produced water containing the high concentration of divalent metal ions, the VES compositions will form a crosslinked gel reducing water production, while not affecting the oil producing zones.

As a profile improving compositions for gas injection wells, VES compositions may be injected into the formation to improve an injection profile of the formation. When gas is injected into a formation with high permeation variation, the gas tends to flow into high permeation areas or channels into such areas, resulting in very poor gas flooding efficiencies. Using these VES compositions, the profile may be improved reducing channeling and improving gas flooding efficiencies.

In most of the historical applications, VES compositions are mixed with acid to yield 3D crosslinked gels, when acid reacts with carbonate formations. But in this invention, VES compositions are added into solutions containing divalent ions that react with the VES compositions to form 3D crosslinked gels, without the need for an acid to react with formation elements to generate divalent agents to gel the VES compositions. Thus, the present composition including a VES system in a divalent ion brine may be used in both carbonate and sandstone formations to equal effect.

Embodiments of this invention relates broadly to methods including placing a fluid including at least one viscoelastic surfactant and at least one divalent metal compound in a well bore adjacent a subterranean formation, and allowing the fluid to penetrate the formation for a time and at a pressure sufficient for the fluid to penetrate into the formation to a desired penetration depth, where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in producing formation and wherein the gel improves an injection profile of injection formation.

In certain embodiments, the viscoelastic surfactants are selected from the group consisting of amphoteric/cationic surfactants, viscosifying amphoteric/cationic surfactants, or mixtures and combinations thereof; and the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof. In other embodiments, the amphoteric/cationic surfactants and the viscosifying amphoteric/cationic surfactants are selected from the group consisting of high-molecular weight, cationic polyacrylamide copolymers, high-molecular weight, partially hydrolyzed polyacrylamides (PHPAs), amines, amine salts, quaternary ammonium salts, amidoamine oxides, betaines, amine oxides, or mixtures and combinations thereof. In other embodiments, the fluid further includes an aqueous base fluid. In yet other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

In other embodiments, the methods further comprise placing the treated formation on production, where the treated formation enhances oil production, while reducing or equalizing gas production and reducing water production. In other embodiments, the methods further comprise pressurizing the gelled fluid for a time and at a pressure sufficient for the fluid to penetrate into the formation to a desired penetration depth enhancing oil production or enhancing gas flooding efficiency, while reducing or equalizing gas production and reducing water production. In other embodiments, the methods further comprise injecting gas into the treated formation, where the gelled fluid enhancing gas flooding efficiency.

Embodiments of this invention relates broadly methods including placing a fluid including at least one viscoelastic surfactant and at least one divalent metal compound adjacent a producing formation penetrated by a well bore; pressurizing the gelled fluid for a time and at a pressure sufficient for the fluid to penetrate into the formation to a desired penetration depth to form a treated formation; and placing the treated formation on production, where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in the producing formation.

In certain embodiments, the viscoelastic surfactants selected from the group consisting of amphoteric/cationic surfactants, viscosifying amphoteric/cationic surfactant, or mixtures and combinations thereof; and the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof. In other embodiments, the an amphoteric/cationic surfactant and a viscosifying amphoteric/cationic surfactant are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof. In other embodiments, the base fluid is an aqueous-based fluid. In other embodiments, the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

Embodiments of this invention relates broadly methods including placing a fluid including at least one viscoelastic surfactant and at least one divalent metal compound and a base fluid adjacent an injection formation penetrated by a well bore; allowing the fluid to penetrate the formation to form a treated formation; and injecting gas into the treated formation, where the metal compounds gel the viscoelastic surfactants to form a crosslinked gelled fluid, where the gelled fluid has desired shear thinning characteristics and where the gelled fluid improves an injection profile of injection formation.

In certain embodiments, the viscoelastic surfactant selected from the group consisting of an amphoteric/cationic surfactant, a viscosifying amphoteric/cationic surfactant, or mixtures and combinations thereof; and the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof. In other embodiments, the an amphoteric/cationic surfactant and a viscosifying amphoteric/cationic surfactant are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof. In other embodiments, the composition may further include a base fluid is an aqueous-based fluid. In other embodiments, the fluid further include at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

Embodiments of this invention relates broadly fluid compositions including at least one viscoelastic surfactant, and at least one divalent metal compound, where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in the producing formations and improves an injection profile of injection formation in injection formations. In certain embodiments, the viscoelastic surfactants selected from the group consisting of amphoteric/cationic surfactants, viscosifying amphoteric/cationic surfactant, or mixtures and combinations thereof; and the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof. In other embodiments, amphoteric/cationic surfactants and viscosifying amphoteric/cationic surfactants are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof. The compositions may further comprise base fluid is an aqueous-based fluid. In other embodiments, the compositions further include at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

The time period and pressure used to facilitate the penetration of the gelled fluid into a formation depends on formation properties and the desired penetration depth. In certain embodiments, the time period is between 1 minute and 24 hours and the pressure is between 5 psi and 25,000 psi. In other embodiments, the time period is between 10 minutes and 24 hours and the pressure is between 5 psi and 10,000 psi. In other embodiments, the time period is between 20 minutes and 24 hours and the pressure is between 5 psi and 5,000 psi. In other embodiments, the time period is between 30 minutes and 24 hours and the pressure is between 10 psi and 2,000 psi.

### Compositional Ranges for Use in the Invention

The VES systems of this invention include a VES composition including at least one viscoelastic surfactant and at least one divalent compound in an aqueous base fluid, where the viscoelastic surfactants and the divalent compounds are present in amounts sufficient to improve gas and/or oil well production.

The effective amounts of the VESs are from about 1 wt. % to about 20wt. % based on the base fluid. In certain embodiments, the effective amounts of the VESs are from about 1 wt. % to about 15 wt. % based on the base fluid. In other embodiments, the effective amounts of the VESs are from about 1 wt. % to about 10 wt. % based on the base fluid. In other embodiments, the effective amounts of the VESs are from about 5 wt. % to about 20 wt. % based on the base fluid. In other embodiments, the effective amounts of the VESs are from about 5 wt. % to about 15 wt. % based on the base fluid. In other embodiments, the effective amounts of the VESs are from about 5 wt. % to about 12.5 wt. % based on the base fluid.

The effective amounts of the divalent compounds are from about 5 wt. % to saturation based on the base fluid. In certain embodiments, the effective amounts of the divalent compounds are from about 5 wt. % to about 30 wt. % based on the base fluid. In other embodiments, the effective amounts of the divalent compounds are from about 5 wt. % to about 25 wt. % based on the base fluid. In other embodiments, the effective amounts of the divalent compounds are from about 5 wt. % to about 20 wt. % based on the base fluid. In other embodiments, the effective amounts of the divalent compounds are from about 10 wt. % to about 25 wt. % based on the base fluid. In other embodiments, the effective amounts of the divalent compounds are from about 10 wt. % to about 22.5 wt. % based on the base fluid. In other embodiments, the effective amounts of the divalent compounds are from about 15 wt. % to about 25 wt. % based on the base fluid. In other embodiments, the effective amounts of the divalent compounds are from about 15 wt. % to about 22.5 wt. % based on the base fluid.

### Suitable Reagents for Use in the Invention

Suitable viscoelastic surfactants for use in this invention include, without limitation, amphoteric/cationic surfactants, viscosifying amphoteric/cationic surfactants, or mixtures and combinations thereof. Exemplary examples of such surfactants include, without limitation, high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof.

Suitable amine oxide viscoelastic surfactants including, without limitations, oxide viscoelastic surfactants of the following general structure:

RR′R″N⁺—O⁻ (I)

where R is an alkyl or alkylamido group averaging from about 8 to 24 carbon atoms and R′ and R″ are independently alkyl groups averaging from about 1 to 6 carbon atoms. In a particular embodiment, which is non-limiting, R is an alkyl or alkylamido group averaging from about 8 to 16 carbon atoms and R′ and R″ are independently alkyl groups averaging from about 2 to 3 carbon atoms. In another particular non-limiting embodiment, the amine oxide is APA-T, sold by Baker Hughes Inc. as part of the SurFRAQ™ fluid system. SurFRAQ™ is a VES liquid product that is 50% APA-T and greater than 40% propylene glycol. In another non-restrictive embodiment, the amine oxide maybe an amidoamine oxide such as Akzo Nobel's AROMOX®. APA-T formulations, which should be understood as being a dipropylamine oxide since the R′ and R″ groups are propyl (see, e.g., structure (I)).

Suitable zwitterionic VES surfactants include, without limitation, zwitterionic VES surfactants having good biodegradability and/or less ecotoxicity, which makes them an attractive VES surfactant choice. Nonlimiting examples of zwitterionic/amphoteric surfactants include dihydroxyl alkyl glycinate, alkyl ampho acetate or propionate, alkyl betaine, alkyl amidopropyl betaine and alkylimino mono- or di-propionates derived from certain waxes, fats and oils.

Suitable aqueous-base fluids include, without limitation, fresh water, brines, seawater, other types of aqueous-fluid suitable for subterranean uses, or mixtures and combinations thereof. The amount of base fluid used will depend on the particular application. One of ordinary skill in the art with the benefit of this disclosure ill recognize the appropriate amount of base fluid to include to reach the final concentrations desired for a chosen application.

Suitable supplemental particulate solid diverting agent includes, without limitation, oil-soluble resins, water-soluble rock salts, emulsions, or mixtures and combinations thereof. Exemplary examples of degradable particulate diverting materials include, without limitation, particulate hydrated organic or inorganic solid compounds, degradable particulate diverting material, material particles having the physical shape of platelets, shavings, flakes, ribbons, rods, strips, spheroids, toroids, pellets, tablets or any other physical shape. The terms “degrade,” “degradation,” “degradable,” and the like when used herein refer to both the two relative cases of hydrolytic degradation that the degradable particulate may undergo, i.e., heterogeneous (or bulk erosion) and homogeneous (or surface erosion), and any stage of degradation in between these two. This degradation may be a result of inter alia, a chemical or thermal reaction or a reaction induced by radiation.

Suitable surfactants that may be used in a liquid or powder form. Where used, the surfactants are present in the fluids in an amount sufficient to prevent incompatibility with formation fluids or well bore fluids. If included, a surfactant may be added in an amount of from about 1/10th of a gal per 1000 gals up to 10% by volume. In an embodiment where liquid surfactants are used, the surfactants are generally present in an amount in the range of from about 0.01% to about 10% by volume of a fluid. In one embodiment, the liquid surfactants are present in an amount in the range of from about 0.1% to about 10% by volume of the fluid. In embodiments where powdered surfactants are used, the surfactants may be present in an amount in the range of from about 0.001% to about 10% by weight of the fluid.

In some embodiments, the fluids of the present invention may be prepared in any suitable tank equipped with suitable mixing means well known to those skilled in the art. The fluids may be transferred either at a controlled rate directly into the well bore or into a convenient storage tank for later placement down the well bore. If the pumping rates and pressures utilized depend upon the characteristics of the formation and whether or not fracturing of the formation is desired. After a fluid has been injected into a well bore, the well may be shut in and allowed to stand for a period of several hours or more depending on the type of acid employed and the formation treated. If there is pressure in the well, pressure then can be released and then the spent or at least partially spent fluid (that likely contains salts formed by the reaction of the acid in the subterranean formation), may be permitted to flow back to the surface for appropriate disposal. The well then can be placed on production or used for other purposes.

Suitable divalent metal compounds for use in the VES systems of this invention include, without limitation, calcium salts, magnesium salts, strontium salts, barium salts, copper salts, zinc salts, manganese salts, or mixtures and combinations thereof, where the counter ions are selected from the group consisting of halides such as fluoride, chloride, bromide; carbonate; hydroxide; carboylates such as formate, acetate, etc.; nitrate; sulfate; phosphate; or mixtures and combinations thereof.

### Experiments of the Invention

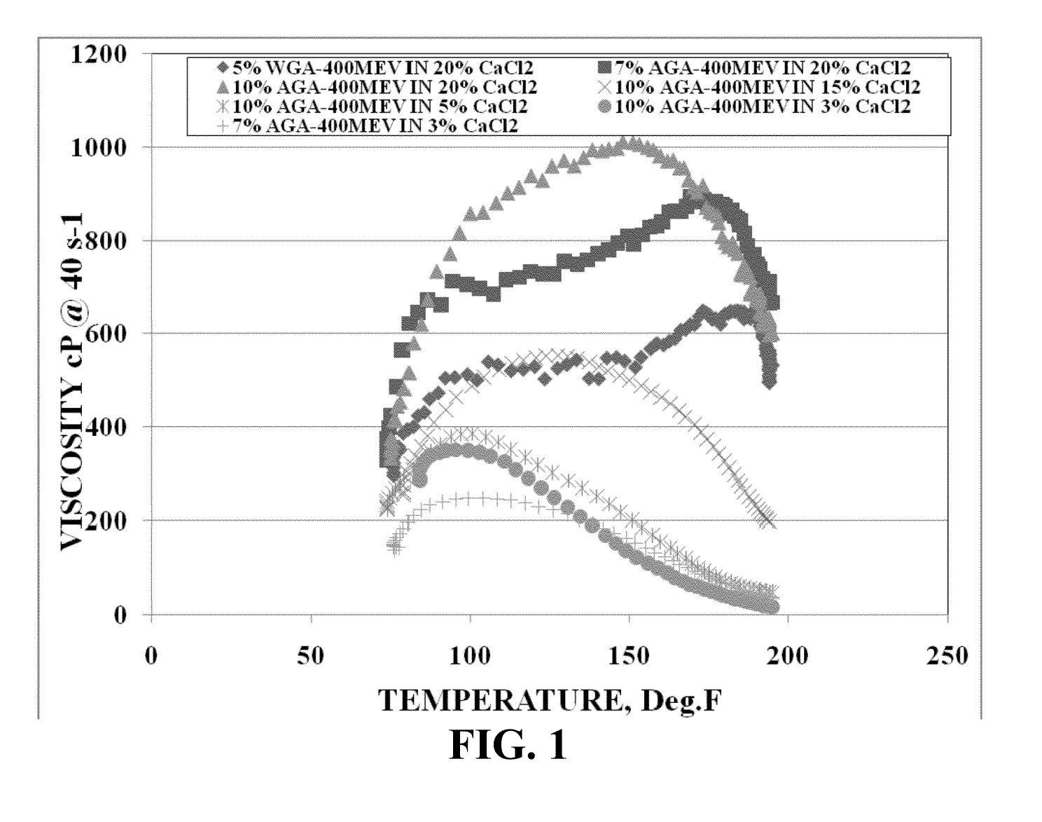

The present examples illustrate the rheological properties of the VES systems of this invention, where the VES surfactant is AGA-400MEV, a cationic, high-molecular weight, polyacrylamide copolymer, available from Weatherford International at different VES concentrations and at different CaCl₂ salinity brines using a Grace Rheometer 5600@40 s^{Δ1} using R1:B2 geometry. Brine concentrations are calculated by percentage (weight salt/volume brine) and the VES solutions in percentage (volume VES/volume brine). Rheological profiles for solutions of AGA-400MEV in 3%, 5%, 10% and 15% and 20% CaCl₂ brine compositions. The systems are designed to be used as a damage free diverting agent. The results of the rheological tests are tabulated in Table 1 and shown graphically in FIG. 1.

TABLE 1
n′ and K′ Values of the Shear Rate Sweeps of the VES Systems Viscosity @200° F.

| | | K′ | Viscosity | Viscosity | Viscosity | Viscosity |
|---|---|---|---|---|---|---|
| FLUID | n′ | (lbf-sec\hat{ }n/ft²) | @ 40 sec⁻¹, cP | @ 1 sec⁻¹, cP | @ 0.1 sec⁻¹, cP | @ 0.05 sec⁻¹, cP |
| 10% AGA-400 MEV in 20% CaCl₂ | 0.435 | 0.0831 | 495 | 3979 | 14613 | 21618 |
| 7% AGA-400 MEV in 20% CaCl₂ | 0.506 | 0.0742 | 575 | 3554 | 11077 | 15597 |
| 5% AGA-400 MEV in 20% CaCl₂ | 0.416 | 0.0822 | 456 | 3936 | 15114 | 22660 |
| 10% AGA-400 MEV in 5% CaCl₂ | 0.399 | 0.0065 | 34 | 313 | 1251 | 1898 |
| 7% AGA-400 MEV in 3% CaCl₂ | 0.468 | 0.0039 | 27 | 189 | 643 | 930 |

From the data, it can be seen that the systems develop an increased viscosity as the temperature increased reaching a maximum and later decreases again. The peak in the viscosity depends mainly in the degree of salinity of the base brine. The present data showed the highest viscosity in 20% CaCl₂ brine systems. The rheological behavior with temperature is typical due to improved interaction in forming worm like micellar structures typical of these VES systems due to the high density of hydrogen bonding interactions in the high salinity environments.

### Laboratory Flow Study

Laboratory flow study were performed in a Formation Response Tester or FRT made by Chandler Engineering. Data were recorded throughout testing with the FRT data acquisition software, and later exported into EXCEL, where the data were processed into relevant tables and charts.

The sample was loaded into the FRT core holder and a net confining stress of 1000 psi was applied. The flow lines were connected and the internal system pressure brought up to 400 psi using 2% KCl, while bypassing the sample. Heat was applied to the core holder until a temperature of 200° F. (93° C.) was reached, while confining stress was maintained at 1000 psi.

For all flow measurements made thought-out testing, a minimum of five pore volumes of flow were required; however, flow continued until a reasonably stable permeability measurement was reached.

Specific brine permeability was measured with 2% KCl in the production direction at a flow rate of 1 cc/min for 20 pore volumes of throughput. This insured that the sample reaches 100% saturation with brine and serves as a reference measurement only.

Ten pore volumes of 7% AGA-400MEV in 10% CaCL₂ was injected in the injection direction at 2 cc/min. A shut-in period of at least 6 hours was applied directly following treatment.

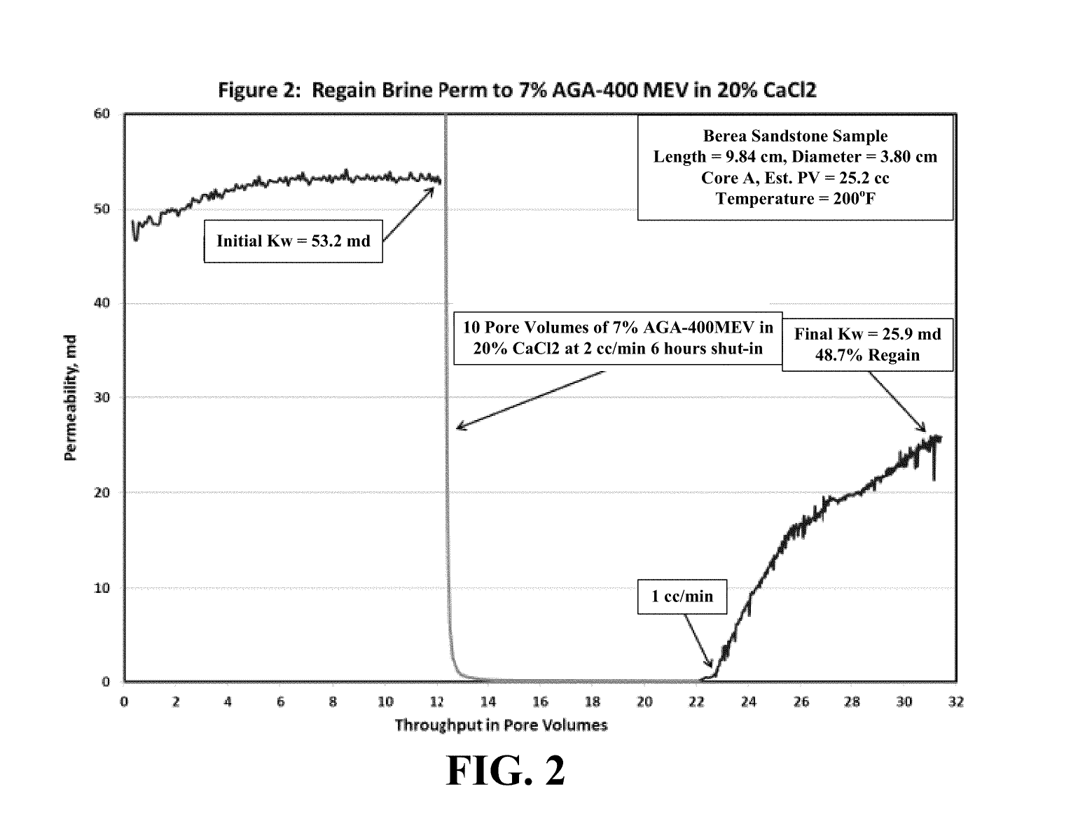

The system was thoroughly flushed with 2% KCL to remove any residual treatment from flow system. The regain brine permeability was measured in the production direction at a flow rate of 1 cc/min for 24 hours. Final regain permeability and RRFw were calculated as shown FIG. 2.

A second test was performed under the same conditions using the same procedure, but the treatment fluid was 7% AGA-400MEV with 20% CaCl₂.

The lab result of these two tests is summarized in Table 2. As can be seen in Table 2 and FIG. 2, a regain perm of 48.7% for the water flow can be achieved using 7% AGA-400MEV in 20% CaCl₂. This indicates that AGA-400MEV in the presence of CaCl₂ will result in water production reduction of around 50%. In formation with low Ca/Mg ions, a 20% CaCl₂ solution can be pumped as pre-flush to precondition the formation to ensure a crosslinked AGA-400MEV can be achieved after the treatment.

Another test was performed by changing the treatment procedure. In this test, core sample was saturated with 2%KCl. The core was treated with 7% AGA-400MEV prepared in 2% KCl immediately following a slug of 20% CaCl₂ solution. This is to simulate a treatment of AGA-400MEV in a well producing formation water containing low concentration of Ca⁺⁺/Mg⁺⁺ ions.

TABLE 2
Water Control Regain Permeability Summary
Confining Stress = 1000 psi/Back Pressure = 400 psi

| | | | Initial Conditions | | | Final Conditions | | |
|---|---|---|---|---|---|---|---|---|
| | Test Fluid | | | 2% KCl | | 2% KCl | | |
| ID | T†(° F.) | Conc. Added | Ka | Kwᵢ^{‡} | Kw/Ka | Kw_{f}* | % Regain | RRFw |
| 1 | 200 | 7% in 10% CaCl₂ | — | 46.9 | — | 33.7 | 71.9% | 1.4 |
| 2 | 200 | 7% in 20% CaCl₂ | — | 53.2 | — | 25.9 | 48.7% | 2.1 |

†Temperature
‡Initial Kw
*Final Kw

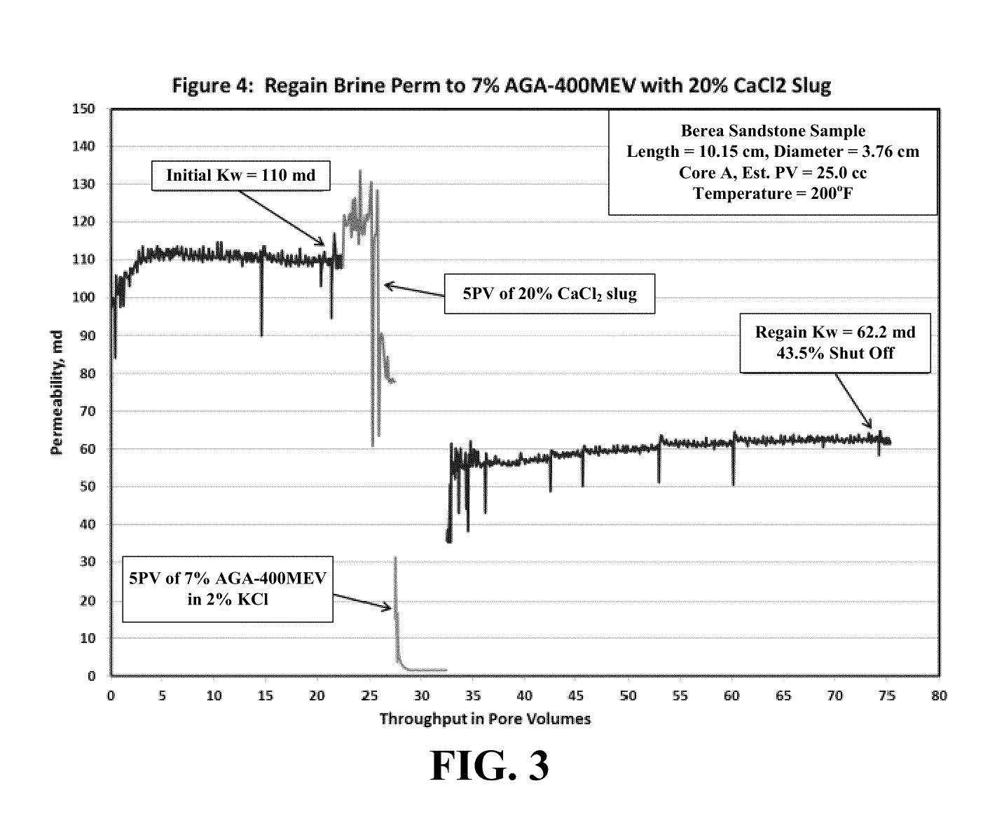

The following result as shown in FIG. 3 shows that if the formation water contains low concentration of Ca²⁺/Mg²⁺ ion, a slug of 20% CaCl₂ pre-flush may be pumped into the formation to precondition the formation to ensure that a crosslinked AGA-400MEV is achieved.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A method comprising:
placing a fluid including at least one viscoelastic surfactant and at least one divalent metal compound in a well bore adjacent a subterranean formation; and
allowing the fluid to penetrate the formation for a time and at a pressure sufficient for the fluid to penetrate into the formation to a desired penetration depth,
where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in producing formation and wherein the gel improves an injection profile of injection formation.

2. The method of claim 1, wherein:
the viscoelastic surfactants are selected from the group consisting of amphoteric/cationic surfactants, viscosifying amphoteric/cationic surfactants, or mixtures and combinations thereof; and
the divalent metal compounds are selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof.

3. The method of claim 2, wherein the amphoteric/cationic surfactants and the viscosifying amphoteric/cationic surfactants are selected from the group consisting of high-molecular weight, cationic polyacrylamide copolymers, high-molecular weight, partially hydrolyzed polyacrylamides (PHPAs), amines, amine salts, quaternary ammonium salts, amidoamine oxides, betaines, amine oxides, or mixtures and combinations thereof.

4. The method of claim 1 wherein the fluid further includes an aqueous base fluid.

5. The method of claim 1, wherein the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent;
a fluid loss control agent; a proppant particulate; a pH-adjusting agent; a pH-buffer; an oxidizing agent; an enzyme; a lost circulation material; a scale inhibitor; a clay stabilizer; a corrosion inhibitor;
a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

6. The method of claim 1, further comprising:
placing the treated formation on production,
where the treated formation enhances oil production, while reducing or equalizing gas production and reducing water production.

7. The method of claim 1, further comprising:
pressurizing the gelled fluid for a time and at a pressure sufficient for the fluid to penetrate into the formation to a desired penetration depth enhancing oil production or enhancing gas flooding efficiency, while reducing or equalizing gas production and reducing water production.

8. The method of claim 1, further comprising:
injecting gas into the treated formation,
where the gelled fluid enhancing gas flooding efficiency.

9. A method comprising:
placing a fluid including at least one viscoelastic surfactant and at least one divalent metal compound adjacent a producing formation penetrated by a well bore;
pressurizing the gelled fluid for a time and at a pressure sufficient for the fluid to penetrate into the formation to a desired penetration depth to form a treated formation; and
placing the treated formation on production,
where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in the producing formation.

10. The method of claim 9, wherein:
the viscoelastic surfactants selected from the group consisting of amphoteric/cationic surfactants, viscosifying amphoteric/cationic surfactant, or mixtures and combinations thereof; and
the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof.

11. The method of claim 10, wherein the amphoteric/cationic surfactants and viscosifying amphoteric/cationic surfactants are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof.

12. The method of claim 9, wherein the base fluid is an aqueous-based fluid.

13. The method of claim 9, wherein the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

14. A method comprising:
placing a fluid including at least one viscoelastic surfactant and at least one divalent metal compound and a base fluid adjacent an injection formation penetrated by a well bore;
allowing the fluid to penetrate the formation to form a treated formation; and
injecting gas into the treated formation,
where the metal compounds gel the viscoelastic surfactants to form a crosslinked gelled fluid, where the gelled fluid has desired shear thinning characteristics and where the gelled fluid improves an injection profile of injection formation.

15. The method of claim 14, wherein:
the viscoelastic surfactant selected from the group consisting of amphoteric/cationic surfactants, a viscosifying amphoteric/cationic surfactants, or mixtures and combinations thereof; and
the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate; hydroxide; carboylates; nitrate; sulfate; phosphate; or mixtures and combinations thereof.

16. The method of claim 15, wherein the amphoteric/cationic surfactants and viscosifying amphoteric/cationic surfactants are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof.

17. The method of claim 14, wherein the base fluid is an aqueous-based fluid.

18. The method of claim 14, wherein the fluid further includes at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.

19. A fluid composition comprising:
at least one viscoelastic surfactant, and
at least one divalent metal compound,
where the metal compounds gel the viscoelastic surfactants to form a crosslinked gelled fluid, where the gelled fluid has desired shear thinning characteristics and desired oil breaking or oil dissolving properties, and where the gelled fluid reduces gas production and water production, while maintaining oil production in the producing formations and improves an injection profile of injection formation in injection formations.

20. The composition of claim 19, wherein:
the viscoelastic surfactants selected from the group consisting of amphoteric/cationic surfactants, viscosifying amphoteric/cationic surfactant, or mixtures and combinations thereof; and
the divalent metal selected from the group consisting of calcium salts, magnesium salts, strontium salts, barium salts, copper salts, zinc salts, manganese salts, or mixtures and combinations thereof, where the counter ions are selected from the group consisting of halides; carbonate;
hydroxide; carboylates; nitrate; sulfate; phosphate; or mixtures and combinations thereof.

21. The composition of claim 20, wherein the amphoteric/cationic surfactants and viscosifying amphoteric/cationic surfactants are selected from the group consisting of viscoelastic surfactant high-molecular weight, cationic polyacrylamide copolymers, high-molecular weight, partially hydrolyzed polyacrylamide (PHPA), amines, amine salts, quaternary ammonium salts, amidoamine oxides, betaines, amine oxides, or mixtures and combinations thereof.

22. The composition of claim 19, further comprising base fluid is an aqueous-based fluid.

23. The composition of claim 19, further comprising at least one additional component selected from the group consisting of: a diverting agent; a particulate solid diverting agent; a degradable particulate diverting material; a self-degradable particulate diverting material; a mechanical diverting agent; a secondary surfactant; a bactericide; a nonemulsifier; a mutual solvent; a fluid loss control agent; a proppant particulate; a pH-adjusting agent; a pH-buffer; an oxidizing agent; an enzyme; a lost circulation material; a scale inhibitor; a clay stabilizer; a corrosion inhibitor; a paraffin inhibitor; an asphaltene inhibitor; a penetrating agent; a clay control additive; an iron control additive; a chelator; a reducer; an oxygen scavenger; a sulfide scavenger; an emulsifier; a foamer; a gas; a breaker; an iron control additive; a derivative thereof; and mixtures or combinations thereof.
